(19) United States
(12) Patent Application Publication
(10) Pub. No.: US 2023/0230023 A1
(43) Pub. Date: Jul. 20, 2023

(54) Collaborative Logistics Platform and Methods Thereof

(71) Applicants: Amirjavad KHALEGHI, Walpole, MA (US); Mohammad Hossein HAJIAN, Boston, MA (US); Majid DARVISHAN, Bloomington, IN (US); Manny NIKJOO, Thornhill (CA)

(72) Inventors: Amirjavad KHALEGHI, Walpole, MA (US); Mohammad Hossein HAJIAN, Boston, MA (US); Majid DARVISHAN, Bloomington, IN (US); Manny NIKJOO, Thornhill (CA)

(21) Appl. No.: 17/952,316

(22) Filed: Sep. 26, 2022

Related U.S. Application Data
(60) Provisional application No. 63/251,035, filed on Oct. 1, 2021.

(51) Int. Cl. G06Q 10/0835; G06Q 10/0631

(52) U.S. Cl. CPC G06Q 10/08355; G06Q 10/06315

(57) ABSTRACT

A system for shipping an object is disclosed. The system can include a routing unit to obtain a set of data associated with the object, generate a first shipping route for the object, and determine a first set of transshipping locations for the shipping route. Each of the first set of transshipping locations can include a location that the object is transferred from a first courier to a second courier. The system can include a scheduling unit to determine an availability for each of the first set of transshipping locations, communicate with parties involved in shipping the object, initiate a shipping process, and orchestrate the shipping process until the object is delivered. Upon a determination that the shipping route does not meet criteria, the scheduling unit can direct the routing unit to generate another shipping route for the object, and determine another set of transshipping locations.

### CROSS REFERENCE TO THE RELATED APPLICATIONS

This application is based upon and claims priority to U.S. Provisional Application No. 63/251,035, Titled “Collaborative Logistics Platform and Methods Thereof” filed on Oct. 1, 2021, the entire contents of which are incorporated herein by reference.

### FIELD

The present disclosure relates to delivery systems. More particularly, the present disclosure relates to delivery systems using collaborative platform.

### BACKGROUND

A hub-and-spoke model is a distribution model in transportation and logistics, which has been used by shippers and carriers to optimize their distribution network design. With the emergence of sharing economy models, the same concept has been used to consolidate loads across multiple shippers/carriers as well.

### SUMMARY

According to an aspect of the present disclosure, a system for shipping an object is disclosed. The system for shipping an object can include a routing unit configured to obtain a set of data associated with the object to be shipped, generate a first shipping route for the object based at least in part on the set of data, and determine a first set of transshipping locations for the shipping route. Each of the first set of transshipping locations can include a location that the object is transferred from a first courier to a second courier. The system for shipping an object can include a scheduling unit communicatively coupled to the routing unit and configured to determine an availability for each of the first set of transshipping locations, communicate with parties involved in shipping the object to initiate a shipping process upon a first determination that the first set of transshipping locations are available, and orchestrate the shipping process along the shipping route until the object is delivered to a final destination. Upon a second determination that the first shipping route does not meet one or more pre-determined criteria, the scheduling unit can be further configured to at least: direct the routing unit to generate a second shipping route for the object, and determine a second set of transshipping locations.

In some embodiments, the first and second set of transshipping locations can include at least one of: a pre-negotiated public transit space, a pre-negotiated private parking lot, a pre-negotiated loading dock, a pre-negotiated retail parking lot, a pre-negotiated curb space, a pre-negotiated building roof, a pre-negotiated bridge, a pre-negotiated private driveway, a dynamically sourced space from a space provider, and a pre-negotiated backyard.

In additional embodiments, the set of data can include at least one of: a pick-up location of the object, a pick-up time window of the object, and a type of vehicle that can perform the pick-up based at least on a size, shape and weight of the object. The set of data comprises at least one of object specifications, a delivery location, and a delivery time window.

In an embodiment, the set of data can include at least a number of available vehicles of each courier, a vehicle capacity of each of the available vehicles of each courier, a vehicle range of each of the available vehicles of each courier, a vehicle size of each of the available vehicles of each courier, a vehicle emission of each of the available vehicles of each courier, a vehicle availability time of each of the available vehicles of each courier, and a cost of shipping process. In an embodiment, the set of data can include at least one of: a location of the final destination, a number of transshipments that a courier can handle at a same time, and an available time of each of the first set of transshipping locations. Each of the set of data can be a location-dependent data or a time-dependent data.

In some embodiments, the routing engine can be configured to determine the first set of transshipping locations based at least on: a cost of total distance traveled associated with the delivery process, a cost of total delivery time, a total cost of transshipping, and an environmental cost of the delivery process, where the total cost of transshipping can include at least a total hub cost and a total waiting cost.

In various embodiments, the set of data can include at least one of a number of available spaces for each of the first and second set of transshipping locations, a notice time needed to secure a space for each of the first and second set of transshipping locations, and a capacity of available spaces for each of the first and second set of transshipping locations. The parties involved in the shipping the object to initiate the shipping process can be at least one of a courier, a shipper of the object, a recipient of the object, and an operator associated with each of the first and second sets of transshipping locations.

In several embodiments, the system for shipping an object can include a simulation unit configured to analyze shipping routes by running one or more simulations based on at least one of: the set of data, the first set of transshipping locations, traffic data along the shipping route, and weather conditions. Each of the first and second couriers can be at least one of: a vehicle, a drone, a bike, a boat, a public transit vehicle, a motorcycle, and an on-foot person. In an embodiment, the one or more pre-determined criteria can include at least one of: an expected delivery window time, and an expected delivery cost.

According to another aspect of the present disclosure, a method for shipping an object is disclosed. The method for shipping an object can include obtaining a set of data associated with the object to be shipped, generating a first shipping route for the object based at least in part on the set of data, and determining a first set of transshipping locations for the shipping route. Each of the first set of transshipping locations can include a location that the object is transferred from a first courier to a second courier. The method for shipping an object can include determining an availability for each of the first set of transshipping locations, and upon a first determination that the first set of transshipping locations of the shipping route are available, communicating with parties involved in the shipping the object to initiate a first shipping process. The method for shipping an object can further include orchestrating the first shipping process along the shipping route until the object is delivered to a final destination, tracking the first shipping process along the shipping route until the object is delivered to a final destination, and upon a second determination that the first shipping route does not meet one or more pre-determined criteria, generating a second shipping route for the object, determining a second set of transshipping locations, and communicating with parties involved in the shipping the object to initiate a second shipping process.

In some embodiments, the first and second set of transshipping locations of the method for shipping an object can include at least one of: a pre-negotiated public transit space, a pre-negotiated private parking lot, a pre-negotiated loading dock, a pre-negotiated retail parking lot, a pre-negotiated curb space, a pre-negotiated building roof, a pre-negotiated bridge, a pre-negotiated private driveway, a dynamically sourced space from a space provider, and a pre-negotiated backyard.

In an embodiment, determining the first set of transshipping locations can be performed based at least on: a cost of total distance traveled associated with the delivery process, a cost of total delivery time, a total cost of transshipping, and an environmental cost of the delivery process. The total cost of transshipping can include at least a total hub cost and a total waiting cost.

In several embodiments, the set of data can include at least one of a pick-up location of the object, a pick-up time window of the object, a type of vehicle that can perform the pick-up based at least on a size, a shape and a weight of the object, and a pick-up hour, one or more object specifications, a delivery location, a delivery time window, a number of available vehicles of each courier, a vehicle capacity of each of the available vehicles of each courier, a vehicle range of each of the available vehicles of each courier, a vehicle size of each of the available vehicles of each courier, a vehicle emission of each of the available vehicles of each courier, a cost of shipping process, a vehicle availability time of each of the available vehicles of each courier, a location of the final destination, a number of transshipments that a courier can handle as a same time, and an available time of each of the first set of transshipping locations.

In various embodiments, the method for shipping an object can further include upon the second determination, updating shipping manifests for the pickup and transshipment. The method for shipping an object can include analyzing each shipping route by running one or more simulations based on at least one of: the set of data, the first set of transshipping locations, traffic data along the shipping route, and weather conditions.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a system for shipping an object in accordance with an embodiment of the disclosure;

FIG. 2 is a conceptual illustration of shipping process using the system for shipping an object in accordance with an embodiment of the disclosure;

FIG. 3 is a conceptual illustration of a set of inputs and outputs for the routing engine of the system for shipping an object in accordance with an embodiment of the disclosure;

FIG. 4 is a conceptual illustration of a set of inputs and outputs for the scheduling engine of the system for shipping an object in accordance with an embodiment of the disclosure;

FIG. 5 is a conceptual illustration of a set of inputs and outputs for the simulation engine of the system for shipping an object in accordance with an embodiment of the disclosure.

FIG. 6 is a flowchart depicting a process for shipping an object in accordance with an embodiment of the disclosure; and

FIG. 7 is a flowchart depicting a process for updating shipping process for shipping an object in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

A hub-and-spoke model is a proven distribution model in transportation and logistics, which has been used by shippers and carriers to optimize their distribution network design. With the emergence of sharing economy models, the same concept has been used to consolidate loads across multiple shippers/carriers as well, driving emergence of new revenue-sharing models, such as order sharing or capacity sharing for logistic service providers (LSPs). Such models, which are in particular used by less-than-truckload (LTL) carriers, may improve fleet utilization by cross-carrier pooling of shipments, resulting in better unit economics. Current technology solutions aim to enable implementing such models at scale (e.g., online freight board, freight bidding platforms).

In response to the problems described above, systems and methods are discussed herein that can efficiently manage and deliver objects. Thus, an object of the present disclosure is to seek opportunities to move the load from one delivery vehicle to another to achieve a desirable outcome such as improving transportation efficiency, increasing delivery speed, reducing environmental impacts from delivery operation, or tailoring delivery experience to the customer's needs and expectations. Another object of the present disclosure is to match the vehicles and find the right meeting points for the transship to take place.

Yet another object of the present disclosure is to achieve a collective optimal point for multiple shippers by finding the optimal solution across the combined network/fleet of the multiple shippers. Yet another object of the present disclosure is to apply the system for shipping an object to various last mile technologies (e.g., delivery robots, drones, etc.).

Disclosed system for shipping an object may apply the hub and spoke concept to the last mile delivery. An aspect of the present disclosure is to improve fleet utilization and unit economics in the last mile by facilitating consolidation of last mile loads across multiple shippers, in a scalable and self-sustaining way and without the need for significant investments in consolidation/transship facilities. To that end, a low cost and efficient vehicle-to-vehicle transfer of goods (hereinafter “transshipment”) is disclosed as a viable option for delivery service providers. Hereinafter, a shipper is a sender of a package (e.g., an e-commerce company, a seller). A courier is an individual or vehicle (e.g., a van, a truck, a drone, a robot, a bike, a car, a boat, a bus, a subway, a motorcycle, etc.) that transports goods. A distribution center (DC) is a facility with storage and fulfillment capabilities. A delivery service provider (DSP) is a carrier with a fleet of couriers that provides transportation services. By last mile, it is meant the last leg of transportation that ends at a parcel receiver's location (e.g., from local DC to a parcel receiver). A last mile leg may be broken into N segments, in which case the first segment from DC, or local depot, to the first transshipment node or parcel receiver is called the first leg of the last mile. Similarly, an n-th leg of last mile means from the (n−1)-th transshipment node to the parcel receiver or the n-th transshipment node.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components.

A function may also be implemented in programmable hardware devices such as via field programmable gate arrays, programmable array logic, programmable logic devices, or the like. Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

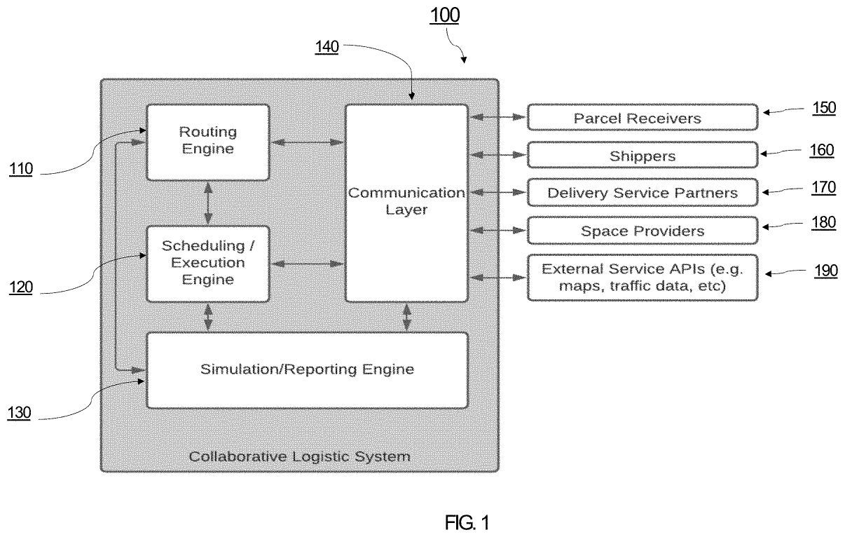

Referring to FIG. 1, a schematic block diagram of a system for shipping an object 100 in accordance with some embodiments of the present disclosure is shown. In some embodiments, the system for shipping an object (i.e., the collaborative logistics system, as shown in FIG. 1) 100 can include a routing engine 110, a scheduling/execution engine 120 (hereinafter “scheduling engine”), and a simulation/reporting engine 130 (hereinafter “simulator”). The routing engine 110, the scheduling engine 120 and the simulation engine 130 can be communicatively coupled together. In various embodiments, the system for shipping an object 100 can include a communication layer 140 which is in communication with the routing engine 110, the scheduling engine 120 and the simulation engine 130. The communication layer 140 can be an interface to communicate with external parties and resources such as parcel receivers 150, shippers 160, delivery service partners 170, space providers 180 and external service application programming interfaces (APIs) 190. The external service APIs 190 can include maps, traffic data, etc.

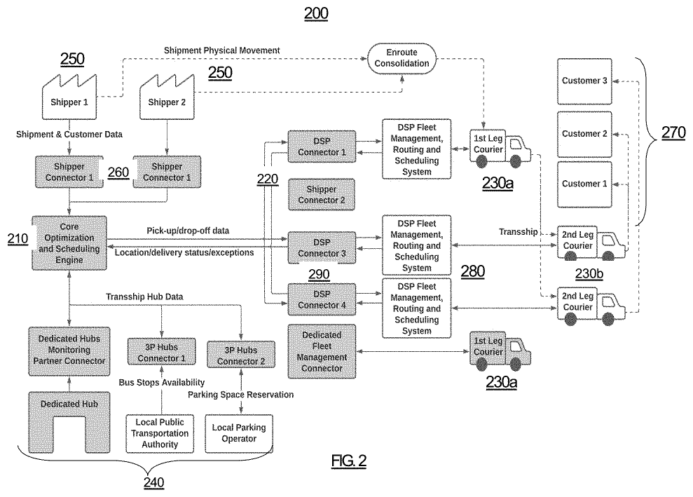

Referring to FIG. 2, a conceptual illustration of shipping process using the system for shipping an object in accordance with an embodiment of the disclosure is shown. FIGS. 1-2 will be used simultaneously to describe the system for shipping an object in more details.

Disclosed system for shipping an object 100 (i.e., the collaborative logistics system) can enable efficient collaborative multimodal last mile delivery. According to some embodiments, the scheduling engine 120 (“core optimization and scheduling engine 210” as shown in FIG. 2) can be a synchronous dispatching platform. The routing engine 110 can solve a variation of a vehicle routing problem to determine whether using a single courier for the last mile is the optimal choice or it would be more efficient to break the last mile into multiple segments and use different couriers for each segment (i.e., collaborative multimodal last mile delivery).

The scheduling engine 120 can be responsible for dispatching and guiding the couriers (such as 1^{st} leg couriers 230a and 2^{nd} leg couriers 230b as shown in FIG. 2) involved in the delivery process to execute the optimal route determined by the routing engine 110. The scheduling engine 120 can orchestrate the whole shipping process through synchronous communication with couriers and any other involved parties such as operators/owners of the spaces at which transshipment takes place. In case of collaborative multimodal last mile delivery, courier types for either of the legs may include vans, trucks, drones, robots, bikes, cars, boats, buses, subway, motorcycles, on foot couriers or any other suitable mode of transportation, and couriers may be part of dedicated delivery fleets or crowdsourced as needed.

One of the systems for shipping an object's core functionalities can be to determine the optimal multi-modal last mile delivery method for a given combination of parcels to achieve a desired outcome (e.g., minimizing cost, reducing pollution, improving speed, etc.). The last mile delivery method can include the number and types of couriers, and the times and locations of courier-to-courier handovers (i.e., transshipments). Another of the system for shipping an object's core functionalities can be to facilitate execution of the last mile delivery method through real-time communication with the involved couriers and owners/operators of the transshipment nodes (such as DSP connectors 220, dedicated hubs monitoring partner connector and/or third-party hub connectors 240, shipper connector 260, DSP fleet management, routing and scheduling system 280, and DSP connectors 290, as shown in FIG. 2).

In some embodiments, transshipment may take place at fixed physical locations such as parking lots, retail loading areas, public transit spaces, available curb spaces, building roofs, under bridges, driveways, backyards, or any other physical space that can accommodate the transshipment operation. In case of using physical spaces that may have other primary applications, the system for shipping an object 100 can ensure minimal disruption to the intended application of the physical space through communication and/or integration with the owner or operator of the physical space. For instance, when bus stops are being used for transshipment, the system for shipping an object 100 can ensure minimal disruption to the operation of the bus system through integration with the public transit operators automatic vehicle location system and using the operators bus schedule data (e.g., GTFS data).

As a non-limiting example, the space providers 180 may include public entities such as cities and local public transportation operators sharing the excess capacity of transit stations, bus stops, transit parking, or any other physical infrastructure they own and operate. As another non-limiting example, the space providers 180 may include private parking operators. Alternatively, the space providers 180 may include retailers with real estate (e.g., loading docks, parking spaces). As yet another non-limiting example, the space providers 180 may include individual homeowners. The space providers 180 may further include curb management service providers who can facilitate shared use of open curb spaces, or owners or operators of any piece of real estate that can be accessed by delivery service providers even for short periods of time. The transshipment capability offered through the system for shipping an object 100 can enable shippers 160 as shown in FIG. 1, or shippers 250 as shown in FIG. 2, to have more transportation options, and seamlessly mix and match services offered by various platform participants. As a non-limiting example, shippers 160 may be able to ship a package using a single courier, or deliver the package to a drop box from another provider. Alternatively, shippers 160 may hand the package over to a robot for the last mile, etc.

In some embodiments, the system for shipping an object 100 can be used in reverse logistics of parcels (i.e., “returns”). Under this scenario, the origins of the parcels may be customers' and final destinations may be the sellers' return processing facilities. In some embodiments, the system for shipping an object 100 can return at the time of delivery and route them to proper return facilities on the fly. The returned parcels, which may or may not be destined to the same return facility, instead of being returned to the origin hub at the end of the day, can be transshipped to other vehicles along the original vehicle's route and directly routed to their respective return processing facilities.

In some embodiments, the scheduling engine 120 can track custody of parcels and communicates the real-time location of the parcels to shippers, involved couriers, involved space providers and parcel receivers. Thus, the system for shipping an object 100 can further improve transportation efficiency, and provide operational flexibility to achieve the desired outcomes for the shipper 160 and parcel receiver 150 by at least one of: reducing cost, minimizing environmental impacts such as pollution, congestion, and safety problems, and/or tailoring parcel delivery experience.

In some embodiments, the system for shipping an object 100 can utilize a blockchain technology to keep a repository of all transshipments and track chain of custody for all parcels being shipped in the system. In such a system a decentralized, shared digital ledger is created to store and share the information about the couriers, transshipment nodes, routes, parcels, shippers, parcel receivers, and any other parties involved.

In some embodiments, the system for shipping an object 100 can create a marketplace for independent carriers or DSPs, such as companies with a fleet of local couriers, drones, bots, bikes, etc. or for individuals, such as gig drivers, to sign up and/or bid for blocks of deliveries created from a single shipper or consolidated from multiple shippers. Packages may be transported by fleets disclosed by the system for shipping an object 100. The fleet disclosed by the system for shipping an object 100 can be dedicated or contracted. Alternatively, the packages may be put out to bid on the marketplace and awarded to DSPs with the most competitive bid. In such cases, there could be several tiers of blocks on the marketplace for different segments of the last mile. Under this model, the system for shipping an object 100 can facilitate the bidding and awarding processes. In addition, any other resources used to facilitate collaborative transportation such as physical spaces used for transshipment, or storage facilities may also be put out to bid on the marketplace.

In some embodiments, the system for shipping an object 100 can be used to create a multi-sided transportation platform involving delivery service providers offering transportation services via various modes of transportation (e.g., trucks, vans, delivery bots, drones, on-foot couriers, etc.), on-demand warehouse and short-term storage service providers (e.g., urban warehouses and fulfillment centers), drop-off locker operators, real estate owners or operators offering spaces that can be used for various logistics-related activities (e.g., transshipment, temporary storage, etc.).

In some embodiments, the system for shipping an object 100 can choose not to use a marketplace for some of the legs and instead use an in-house fleet or dedicated partners. In some embodiments, the system for shipping an object 100 can act as a combinatorial exchange platform in which participating shippers or carriers load their upcoming deliveries/routes and the collaborative logistics system finds and recommends optimal multimodal delivery opportunities across multiple shippers or carriers. The optimal delivery method may include shippers or carriers not on the combinatorial exchange platform, in which case these shippers or carriers will be notified to participate, if desired. In some embodiments, the system for shipping an object 100 can be a smart fleet management tool that identifies potential multi-modal delivery opportunities in real-time. As an example, the system for shipping an object 100 can recommend alternative multi-modal routes to en-route couriers when there is a deviation from their original routes or there is a possibility of missing delivery windows for upcoming deliveries.

In some embodiments, the system for shipping an object 100 can pre-bundle parcels on a courier for easier transshipment to the following couriers. In such embodiments, the loading compartment in the prior leg courier may be made of smaller detachable compartments, which can be handed over to the next couriers at the time of transshipment. Detachable compartments may be dropped off at the transshipment hub by the prior leg courier to be later picked up by the next courier.

In some embodiments, the system for shipping an object 100 can create a subway-like system for goods in which fixed routes are served by high-capacity vehicles. The high- capacity vehicles can receive, or hand over, bundles of parcels at transshipment hubs along their routes. In such embodiments, the parcels are transported on the same vehicle for the common portion of their journeys, the same way that subway passengers share the same train. The transshipment locations are analogous to transit stations in a subway system.

In some embodiments, the system for shipping an object 100 can enable delivery service providers to consolidate volumes across multiple carriers to build economies of scale and improve transportation efficiency. As a non-limiting example, a local autonomous delivery service provider operating as a second leg courier may be able to deliver packages consolidated on the first leg by combining shipments from multiple shippers.

In some embodiments, the system for shipping an object 100 can enable couriers with limited range of operation (e.g., delivery bot companies operating within a few miles radius of a local fleet hub) to use the collaborative logistics system, to deliver parcels coming from shippers from hundreds or thousands of miles away. In such embodiments, the system for shipping an object 100 can enable such couriers with limited range of operation to get delivery orders that they would not have received otherwise.

In some embodiments, the system for shipping an object 100 can enable providers of transportation technologies with limited operating range to expand their geographical presence. Being limited to pick up and delivery of parcels within a few-miles radius of a local hub, the transportation technologies (e.g., delivery bots) can only be commercially deployed in geographical areas where there is enough number of shippers and parcel receivers within the same area. As a non-limiting example, the system for shipping an object 100 can serve the grocery stores or supermarkets delivering to local residents by such transportation technologies. The system for shipping an object 100 can enable providers of such transportation technologies to deploy to regions where there might not be many shippers but there is still enough demand for delivery services from shippers outside the area. As a non-limiting example, a delivery bot company may be able to deploy its fleet to serve a residential area where there is no retailer or shipper, but residents receive parcels coming from shippers outside the area.

In some embodiments, the system for shipping an object 100 can be deployed as a smart city platform, used by cities, to facilitate adoption of mobility and transportation technologies (e.g., bots and drones), to find applications for their transportation infrastructure (e.g., bus stops), and to create partnership opportunities with private mobility players. Through the system for shipping an object 100, the private mobility players may be able to work seamlessly alongside each other to achieve an improved collective outcome and reduce the environmental impacts of their operations. As a non-limiting example, the system for shipping an object 100 can enable different autonomous delivery service providers to use the underutilized capacity of public spaces and share these spaces with other mobility players, as opposed to building dedicated hubs for their fleets. In some embodiments, the system for shipping an object 100 can be used to deliver to building complexes, apartment buildings, residential communities, or walk-only communities that are served by a fleet of dedicated autonomous delivery vehicles (e.g., bots, drones, etc.). In such embodiments, the parcels are transshipped to the dedicated delivery vehicles at transshipment hubs located at the periphery of the complex/community or at designated locations within the complex. The dedicated fleet of vehicles will do the final delivery. A non-limiting example could be parcels transshipped to delivery drones stationed close to an apartment building to be airdropped at the parcel receivers' balconies.

Similarly, the system for shipping an object 100 can be deployed to make deliveries to large facilities with a few entry points but multiple end delivery points within the facility. The entry points may be gated and as such access of outside couriers may be limited. In such embodiments, the parcels may be transshipped at the entry points to other couriers, which can operate within the facility. Examples include, but not limited to, delivering building material to various parts of an under construction industrial facility or delivering parcels to different rooms in a large multi-level building such as a hotel.

The system for shipping an object 100 can enable parcel receivers to customize their delivery experience and select their preferred mode of transportation for the final leg of last mile delivery. Customers' preferred mode of transportation may be based on security reasons, environmental considerations, safety factors, health concerns, or limited access of certain types of courier to the delivery location. A customer may opt for having the parcel delivered by an autonomous delivery vehicle, an on-foot courier, a delivery bike or any other courier option that can reach their location, regardless of its operating range.

In some embodiments, the system for shipping an object 100 can further facilitate transit oriented development (TOD), which involves creating walkable commercial and residential areas around major transit hubs. Conventional transportation vehicles (e.g., vans, trucks, etc.) have limited access to these areas, making TOD areas great candidates for local last mile delivery technologies (e.g., delivery robots and drones). There are usually several feeder lines (e.g., bus lines) going into/out of major transit hubs. Bus stations on such feeder lines located at or close to the transit hub, which could still be accessed by delivery vehicles, could be good candidates for transshipment hubs. The system for shipping an object 100 can enable the delivery vehicles to handover parcels to such local last mile couriers serving the TOD area for final delivery.

In some embodiments, the collaborative logistics system enables cities to efficiently enforce policies and ordinances governing the operation of private players in the mobility space. As a non-limiting example, when a city allows controlled use of public spaces (e.g., open curb, loading zones, bus stops, etc.) for the transshipment operation, the system for shipping an object 100 can provide complete visibility to the city into how those spaces will be used by delivery service providers. The system for shipping an object 100 can be combined with on-site monitoring devices (e.g., occupancy or vehicle detection sensors, cameras, in-ground sensors, or any other suitable monitoring technologies) to ensure that the shared public spaces will only be used as authorized by the city. An example is using the system for shipping an object 100 to enforce restrictions on illegal parking or stopping at bus stops by delivery vehicles or ride sharing services, which is generally difficult to enforce for the cities.

In some embodiments, the system for shipping an object 100 can be used by the authorities to apply restrictions on allowable methods of delivery for certain geographical regions, due to safety reasons, security considerations, special occasions such as rallies or outdoor public events or any other reasons. As a non-limiting example, city officials may use the system for shipping an object 100 to temporarily limit operation of autonomous delivery vehicles, such as drones, in an urban area where a rally is scheduled to take place or limit access of heavy delivery trucks to a street that has been recently resurfaced. In some embodiments, the system for shipping an object 100 can use transit stations as transshipment hubs, in which case it can collect near real-time anonymized demographic data about the communities living near these transit stations. This data can significantly help cities' transportation and urban planning initiatives. Information about the deliveries (e.g., volume, frequency, etc.) flowing through a public transit stop used as a transshipment hub can provide near real-time insights into the population living close to the stop.

In some embodiments, the system for shipping an object 100 can be used to facilitate maintenance of micro-mobility solutions installed near public transit stations. E-bikes, e-scooters and other similar micro-mobility technologies can be viable solutions to address first and last mile challenges for public transit riders, so a preferable location for docking/parking such micro-mobility equipment is close to the transit stops. The system for shipping an object 100 can enable operators of such equipment to better maintain and service their fleet with minimal impact on the operation of the public transit system.

In some embodiments, the system for shipping an object 100 can be used to enable cities to monetize the excess capacity of their assets or physical infrastructure (e.g., public transit vehicles, transit stops, dedicated bus lanes, subway etc. For instance, dedicated transit lanes have been created out of a need for smooth flow for buses in absence of an efficient mechanism to share the road with other vehicles. The system for shipping an object 100 can enable cities to use these dedicated lanes for more than just public transit vehicles and to allow controlled use of these lanes by delivery service providers for goods transportation.

In some embodiments, the system for shipping an object 100 can be used to create a collaborative transportation platform offering on-demand delivery services directly to parcel receivers whether or not the shipper is integrated with the platform. A sample use case is on-demand point-to-point deliveries where the receiver requires a customized delivery experience. An example includes delivering an engagement ring with a robot or drone to a particular location at a certain time. For such use cases a single modal delivery process may not work as the robot or drone may not have a long enough operating range to travel between the pick-up and delivery locations. The system for shipping an object 100 can enable the item to be picked up by one mode of transportation and eventually transshipped to the preferred mode of transportation only for final delivery.

In some embodiments, the system for shipping an object 100 can be used to distribute products to multiple retail locations scattered throughout an urban area. Examples are chain retailers with multiple locations, which each receive frequent deliveries from a central distribution center. Under such scenarios, the delivery vehicle that ships products from the distribution center, instead of making multiple stops at each store location, can ship products to optimally selected transshipment locations and hand over deliveries to smaller local couriers for final delivery. The transshipment location may even be chosen to be at one of the store locations that should receive a delivery.

In some embodiments, public transit vehicles may be used as one or more of the delivery service providers involved in the transshipment process. As a non-limiting example, a parcel may be transshipped to a bus at a bus stop, shipped on the bus to another bus stop and then handed over to another courier for final delivery.

In some embodiments, the system for shipping an object 100 can deliver goods to rural regions using rural bus lanes as couriers and/or rural bus stops as transshipment hubs. For instance, a parcel may be shipped from a distribution center in a nearby major city to the rural bus station located in the same city. At the station, the parcel can be transshipped to a rural bus destined to the rural region where the final parcel receiver is located. Finally, the parcel may be either dropped off at the destination station to be picked up by the parcel receiver at a later time, or again handed over to a final courier to be delivered to the parcel receiver. In some embodiments, the system for shipping an object 100 can be used to make deliveries to moving receivers. As a non-limiting example, a parcel receiver may require that the parcel is delivered to him on the go, in which case the collaborative logistics system guides the parcel receiver to meet the final courier and receive the parcel at an optimally located transshipment node. As another non-limiting example, the system for shipping an object 100 can be used to feed en-route couriers or divert deliveries to another en-route courier.

In some embodiments, transship points may include a set of fixed facilities equipped with required loading/unloading equipment. Alternatively, in some embodiments, transship points may include a set of preselected on-/off-street spaces with no particular equipment (e.g., private parking lots, loading docks, retail parking facilities, public transit spaces). In some embodiments, transship points may include any meeting point where the couriers can meet to exchange loads. In some embodiments transshipment may occur while one of the couriers is landed on or attached to another moving courier. In some embodiments, one or both couriers might be moving during transshipment. As a non-limiting example, an on-foot courier may receive a parcel or set of parcels from a moving vehicle.

In some embodiments, transshipments may occur between couriers of multiple shippers or carriers. In some embodiments, transshipments may occur between multiple couriers of the same shipper or carrier.

In some embodiments, at least one courier may stop for a period of time at a transshipment node during the transshipment operation. In some embodiments, at least one courier may be moving during the transshipment operation. In some embodiments, the couriers involved in the transshipment operation may meet at a moving platform, in which case the moving platform acts like a transshipment node.

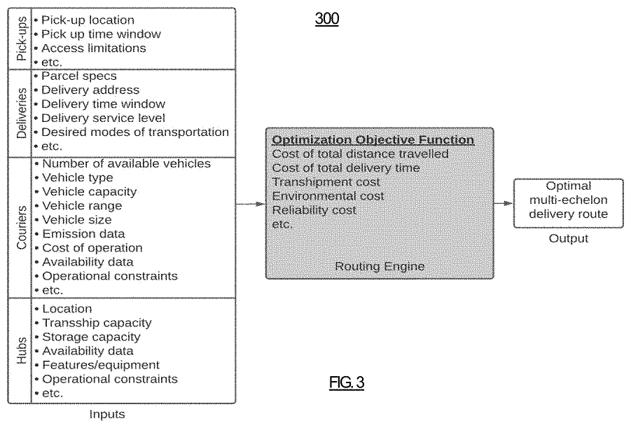

Referring to FIG. 3, a conceptual illustration of a set of inputs and outputs for the routing engine of the system for shipping an object in accordance with an embodiment of the disclosure is shown. In some embodiments, the routing engine 110 can create the routes for the couriers involved in the multi-modal delivery process and picks the optimal transshipment locations after taking into account relevant inputs and constraints. The suggested transshipment locations from the routing engine output could be a neighborhood or a region (and not necessarily the exact location). The final exact locations may be selected by the scheduling engine 120 based on the real-time data at the time of execution. As shown in FIG. 3, the inputs (tuning parameters) of the routing engine 110 can include:

Pick-Ups: Pick-ups can at least include pick-up locations, pick-up time windows, access limitations (e.g., types of vehicle that can perform pick-ups, pick up hours, etc.)

Deliveries: Deliveries can at least include parcel specifications, delivery locations, delivery time windows, delivery service levels (e.g., outdoor drop-off, white glove, etc.), and desired modes of transportation.

Couriers: Couriers can at least include the number of available vehicles, vehicle type, vehicle capacity, vehicle range, vehicle size, vehicle emission data, cost of operation, vehicle availability time, and any relevant operational constraints. All of these inputs can be location-dependent or time-dependent.

Hub data: For the purpose of determining optimal transshipment locations, the routing engine 110 can be given a curated list of potential transshipment sites or may create a list of qualified transshipment sites based on some given constraints. The characteristics used to determine site qualification may include at least one of: Location: latitude/longitude or street address, Transshipment Capacity: number of transshipments that the hub can handle at the same time. Capacity may be defined in terms of vehicle types and their numbers. Example: 1 car, 4 bikes, Storage capacity: the information about the volume of the parcels that can be temporarily stored at the hub. Storage may be available only during certain times or for certain types of packages, Availability: the available times that the transshipment hub can be accessed. For example, in case of using bus stops as potential transshipment hubs, the availability of sites may be determined by the bus schedule, and Features: the equipment or features that may affect site qualification such as weather protection, material handling equipment, security devices, etc. Cost objective function:

In some embodiments, a cost objective can be defined for the routing engine 110. The cost objective function can define the objective the routing engine 110 seeks to achieve to get to the optimal solution. For a certain route, the cost objective function can include a weighted combination of: Cost of total distance travelled (for total route and/or certain segments/couriers), Cost of total delivery time (for total route and/or certain segments/couriers), Total transshipment costs (including but not limited to hub cost and waiting cost), Environmental costs (including but not limited to pollution, congestion, and safety for total route and/or certain segments/couriers), Total reliability costs (including but not limited to cost of damage, loss, insurance and late delivery), Any other direct or indirect cost that may be incurred as a result of executing the route. Such costs may be functions of multiple factors, including, but not limited to courier characteristics (e.g., size, capacity), time of service, type and characteristics of packages, service level performed, environmental impact, and demand surge.

In various embodiments of the present disclosure, the transshipment can be optional, pick-ups can be done by different couriers from different DCs, Couriers may or may not return to their pick-up locations after completing a trip and may be dispatched for more than one trip during a certain day. In some embodiments, there can be some storage capacity at transshipment hubs, relaxing the need for both couriers to be present at the same time or adding the flexibility that parcel receivers themselves could pick up their parcels from the hub, and the transshipment time and duration can be functions of multiple factors such as the volume being transshipped, parcel characteristics, courier characteristics, transshipment hub characteristics, and time. In some embodiments, there may or may not be a limitation on the volume of load that is allowed to be transshipped at a certain hub, while there may be a limit cap on the number of couriers that can be called to a hub. In some embodiments, there may be cases that more than one courier is involved in one or both sides of transshipment (e.g., two first leg couriers handing over to a single second leg courier; one or two couriers handing over to three last leg couriers). Additionally, in some embodiments, load optimization considerations such as dead spaces in the vehicles, stackability, safety and load damage factors may be taken into account when solving for the optimal route. Further, in some embodiments, if a delivery address is not recognizable or reachable by the last leg courier (e.g., courier cannot be routed to the exact location because it is in the middle of a park or mall), the routing engine can use the nearest street address. In some embodiments, the routes may be regenerated, after the initial run, depending on changes in inputs, and traffic information and conditions can be based on real-time or historical data or generated by statistical or machine learning algorithms.

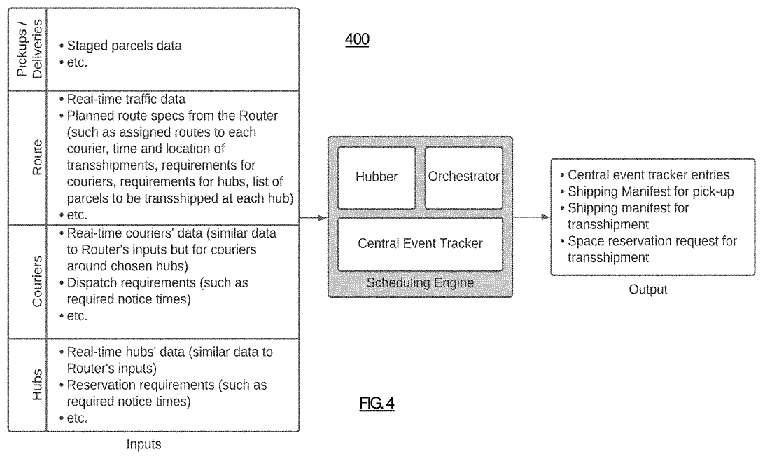

Referring to FIG. 4 now, a conceptual illustration of a set of inputs and outputs for the scheduling engine of the system for shipping an object in accordance with an embodiment of the disclosure is shown. In some embodiments, the scheduling engine 120 can be responsible for activities related to the execution of the routes, handling exceptions, communication and interaction with the involved parties such as shippers, receivers, couriers, owners/operators of transshipment locations, etc. The scheduling engine 120 can ensure that the couriers involved in a transshipment meet at the planned time and location where and if needed as determined by the routing engine 110. Coordination includes sending dispatch signals to the receiving couriers and sending reservation signals to the transshipment hubs (when needed) with outside data sources. For example, if the routing engine 110 needs to have an integration with a delivery service partner to pull necessary data for route calculation, and the scheduling engine 120 needs to have an integration with the same partner as part of route execution, both of these integrations would be through the same gateway housed in the communication layer. In some embodiments, the scheduling engine 120 can at least include

Hubber: A hubber can be a local optimizer which is configured to check the available spaces in the vicinity of a transshipment location suggested by the routing engine 110 to select the final location based on the real-time data and dynamic considerations.

Orchestrator: An orchestrator can house the logics and other software used for triggering communications to the partners and couriers. The orchestrator may receive transshipment locations from the hubber or the routing engine 110 and may further notify the involved parties.

Central event tracker: A central event tracker can be a feature of the scheduling engine 120 for the events happening throughout the delivery process. The central event tracker may be responsible for business decisions; tracking parcels and couriers; and customer, courier or partner communications (e.g., when to reserve the spot, when to mark an item shipped, when to notify the next courier, etc.). The central event tracker may be configured to ensure that the reference times used by various systems are housed, recorded, and retrieved from a single source.

It should be noted that, in some embodiments, one or more of the hubber, orchestrator, and central event tracker are integrated into one component. Alternatively, in an embodiment, the scheduling engine 120 can perform the tasks of each of the hubber, orchestrator, and the central event tracker. Further, the scheduling engine 120 can have the option to call on the routing engine 110 to update routes, should the scheduling engine 120 encounter unforeseen or changes during execution . In some embodiments, the scheduling engine 120 can be configured to make exception handling (e.g., handling unplanned events that may happen during execution).

As shown in FIG. 4, the inputs (tuning parameters) of the scheduling engine 120 can at least include:

List of the parcels staged for pick-up: The list of the parcels staged for pick-up can be the same as the routing engine 110 list. For instance, a shipper first provides a list of parcels to be shipped, which is the list that the routing engine 110 uses. Afterwards, once the routes are generated the shipper is notified about the parcels that will be picked up, the couriers that will do the pick-ups and times of the pick-ups. The shipper is then required to stage the parcels for pick-up. Once staging is done, the shipper sends a second list of the items staged for pick-up, which may be different from the original list. Major deviations from the original list may result in triggering a re-route (i.e., the scheduling engine 120 calling on the routing engine 110 to recalculate the routes). Output of the Routing engine (planned route): the information about the routes, couriers, and the transshipments including, but not limited to, the routes, the time and location of the transshipments, requirements for the couriers (e.g., size, type, etc.), requirements for transshipment hubs, expected duration of transshipments, parcel IDs, couriers IDs, and pick-up and delivery location for each parcel, expected total duration of delivery.

Courier data: Courier data which can include the availability of each courier (e.g., when, and where a courier will be available), courier characteristics (e.g., type, size, range, capacity, limitation, cost, a unique identifier), the type and number of couriers that could be called in at each transshipment hub and how much advance notice is needed to be given to couriers or courier operators to secure a certain courier at a transshipment hub at a specified time (e.g., 10 bikes are near the hub, 2 of the bikes can arrive in 4 minutes, 3 of them in 6 min, etc.). Courier availability data may be pre-negotiated with the delivery service providers and given to the Routing engine and Scheduling engine or dynamically sourced from the delivery service providers.

Space data: Space data can include the number, requirements, characteristics (e.g., costs), and capacity of available spaces, the time during which the spaces will be available, the notice time needed to secure a space. The space availability data may be pre-negotiated with the space providers or dynamically sourced from the space providers. In case of using transit spaces (e.g., bus stops), the space availability data may be sourced from the public transit operators as GTFS data or dynamically collected from the real-time locations of the transportation vehicles using the spaces.

The Hubber: Hubber can operate as a local optimizer to validate and, if needed, change the routing engine's suggested transshipment locations based on the real-time data at the time of execution. The inputs can at least include real-time locations of the couriers, real-time space availability data (e.g., real-time locations of the buses heading to the target bus stop and the stops nearby), real-time traffic data for the region, courier specification data (e.g., courier modal and size), Space data (e.g., capacity and exact location), the number, volume, and characteristics of transshipments, and the required time for transshipment(s).

The hubber may be called to confirm viability of completing a transshipment at a certain planned hub. The hubber can be triggered for a transshipment hub by the scheduling engine 110 or based on a given business logic such as “X min before the courier is expected to arrive at the selected hub”. The hubber can then create a list of potential alternative transshipment hubs. Subsequently, the hubber can check the feasibility of transshipments at each location. For instance, a hub candidate may be checked against the requirements of using that space (e.g., sufficient notice time, etc.), the time needed for transshipment, etc. The hubber can further rank the feasible candidates based on an objective function (e.g., having the lowest actual+reliability cost (i.e., cost of failing), having the smallest impact on the next transshipment). In some embodiments, output of the hubber may include the optimal transshipment locations, objective function value for the winner, notice requirements for the selected hub (i.e., how much in advance of the transshipment the space providers, couriers, should be notified).

In some embodiments, the orchestrator can receive the output of the hubber or the routing engine 110, notify the involved parties, and communicate the required information (e.g., courier's identifiers; access codes for bots, drones, or spaces; etc.) at the right time. The orchestrator can be configured to check the requirements of parties involved in transshipments and call them in time so that the transshipment operation can be completed as planned.

In some embodiments, the central event tracker is a central table that may record and predict the relevant information for each parcel starting from when a shipper submits an order to the routing engine 110 until delivery. The central event tracker may also be responsible for interactions and communications with the parties involved (e.g., couriers, space providers, delivery service providers, parcel receivers, public transit operators). An application of this timetable may be to have a single source of truth for the data needed for various triggers.

The outputs of the scheduling engine 120 can at least include: all the planned times out of the routing engine, which can include at least: the pick-up times from shippers, and transshipment times, delivery times; the hubber data (which can include at least the updated transshipment times from the hubber, hubber lock time stamps, latest notice times for space providers, customers and couriers). It should be noted that, the aforementioned outputs can be overwritten multiple times. The outputs of the scheduling engine 120 can further include all actual times which can include at least: the time stamps for shipper submission, route generated, route confirmed to shipper, ready for pick-up, pick-up time from the shipper, arrival time at each transshipment hub, transshipment time, and delivery time. The outputs of the scheduling engine can further include partner communication times which can include at least the time stamps for the manifest sent, manifest confirmation, space reservation request sent, and space confirmation. The outputs of the scheduling engine can include shipping manifest for pick-up which can include at least: detailed information about the couriers assigned to the pick-up (e.g., type of couriers, courier identifiers (e.g., plate number), driver names and numbers (if applicable), activation or access code for bots and drones, etc.). Further, the outputs of the scheduling engine can include time and location of pick-up and the list of the items to be picked at each pick-up point by each courier. The parcels may be grouped based on their delivery locations or other criteria.

The outputs of the scheduling engine 120 can further include: shipping manifest for transshipment which can include at least detailed information about the couriers assigned for transshipment (e.g., type of couriers, courier identifiers (e.g., plate number), driver names and numbers (if applicable), activation or access code for bots and drones, access code for locker or storage unit, etc.); time and location of transshipment; list of the items to be transshipped or stored. Further, the outputs of the scheduling engine 120 can include space reservation request for transshipment may include time and duration of transshipment; information about the couriers assigned for transshipment (e.g., type of couriers, courier identifiers (e.g., plate number), driver names and numbers (if applicable) etc.). In case that some information may not be available at the time of request, the information may be given to the space provider later on when it becomes available (if needed).

Outputs may be communicated to partners in time to make sure that pick-ups, transshipments, deliveries happen as planned. The orchestrator may determine the times to trigger the outputs based on requirements of parties involved, the dates, and times recorded in the central events timetable, and real-time data regarding traffic, availability of spaces and couriers. A confirmation mechanism may be used for each output, which may allow or trigger some subsequent actions or communication with the involved parties. As a non-limiting example, once a courier confirms its receipt of the parcels in its manifest, the Scheduling engine is clear to send the manifests to the next couriers and/or trigger the reservation requests for a transshipment hub.

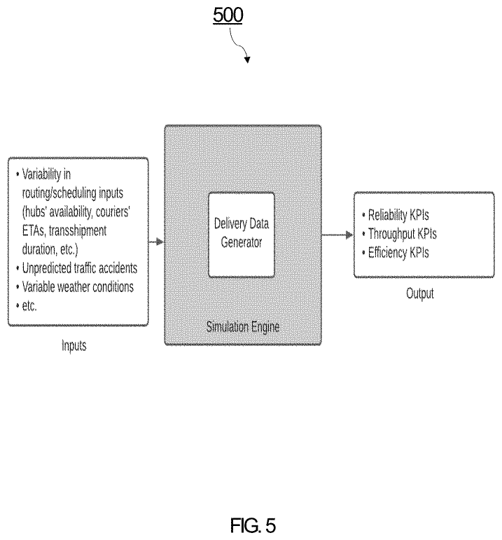

Referring to FIG. 5 now, a conceptual illustration of a set of inputs and outputs for the simulation engine 140 of the system for shipping an object in accordance with an embodiment of the disclosure is shown. The simulator engine 140 can aim to replicate real-world interactions for the purpose of simulations run for feasibility analysis, parameter tuning, what-if analysis, or other similar use cases. The simulation engine 140 can include a data modeler that feeds into a replica of the production system. A subcomponent of the Simulator would be a delivery data generator, which generates dummy parcel data, such as destinations, parcel characteristics, delivery expectations, etc. In some embodiment, the simulation engine 140 can create the capability to simulate and perform scenario analyses for the collaborative logistics system under real world conditions. More specifically, the simulation engine 140 can understand how the collaborative logistics system would handle variability of inputs and how static and dynamic changes in inputs may impact the system's performance. To model variability of inputs, historical data from real deliveries may be used to create a distribution of the expected values of each input. Examples of inputs that the system for shipping an object can consider when running simulations can include hub's availability (e.g., for parking garages, times when they are at full capacity; for bus stops, expected actual bus arrivals and departures); couriers' ETA (e.g., how early or late the couriers may arrive vs SLA); disruptions to normal conditions caused by car accidents or construction (how construction in one area or street, or traffic accidents would affect couriers' ETA and delivery time); courier traffic accidents (how delivery time and process would be affected if a courier had an accident); transshipment duration (how much more or less it would take to complete a transshipment operation versus the expected duration); and weather conditions (how weather conditions affect couriers ETA, delivery time, and transshipment duration).

The outputs of the simulation engine 140 can include a number of KPIs such as reliability; fulfilment rate (total parcels delivered/the number of requested deliveries); transshipment fail rate (total parcels that failed to be transshipped, for various reasons, over the total number of scheduled parcel transshipments); on-time delivery rate (number of parcels that were delivered within their expected time window over the total number of parcels delivered); throughput; average delivery time per parcel; average miles driven per parcel; number of deliveries per hour; efficiency; cost per delivery: (e.g., total courier cost+total transshipment cost)/total parcels delivered); Total pollution: e.g., average CO2 production per vehicle type per mile times miles travelled; congestion; average transshipment time (e.g., total transshipment time/the number of transshipments); courier utilization (e.g., the average percent utilized capacity of couriers); space (e.g., bus stops) utilization (e.g., average time spaces are utilized over their total available time)

Delivery Data Generator: The simulation engine 140 can include a delivery data generator to generate dummy order data to be used for various simulation scenarios. In some embodiment, this component may take geographical area or zip code and delivery period as inputs, and generate a number of records consisting of a delivery address, parcel characteristics (e.g., size, weight, and any other dimensions) that the collaborative logistics system may have for a real order. To enhance the quality of the generated data, the delivery data generator can use other inputs such as average household income for the target region; number of deliverable addresses in the target region; population or number of households living in the region; and other demographic data that may be available for the target region.

The dimensions and weights of the parcels can be generated based on historical order or be predicted based on other relevant information. The model may account for the expected volume variation over time (e.g., general time trend, variation across days of the week, special occasions, etc.). The generated order data may be compared against the historical actual data to make sure that the generated data are in line with the expectations.

The communication layer can house the integrations with shippers and various partners as well as service APIs used by different components of the collaborative logistics system. The communication layer can further act as the point of contact. Integration options with shippers can include an application or portal to order shipments (e.g., uploading a file with the list of deliveries needed). The shipper will likely get updates on the status of the shipments through the same portal/app (or notifications defined there); Flat File Protocol (FTP); Electronic Data Interchange (EDI); Extensible Markup Language (XML); Software Developer Kit (SDK); Application Programming Interface (API). Integration with delivery service partners may take place via APIs or other types of integrations (given the need for real-time communication to coordinate the transship operation). If the internal transportation or fleet management system used by those partners did not offer the functionalities needed for the transshipment operation or did not offer the needed integration connectivity, the integration may involve building web or mobile applications to be used by those partners.

In some embodiments, the system for shipping an object can utilize a routing algorithm which can take into account factors that may have material impact on optimization solutions. Some of the factors are stochastic in nature (e.g., customer requests, the number of demands at each drop-off location, transshipment time and courier availability). A change in each of these factors could result in making the previously constructed solution sub-optimal and, thus, the need for re-optimization. This may call for frequent re-runs, which consequently leads to high computational costs. In addition, altering a driver's schedule sporadically may not be possible because it could create confusion and chaos as well as unnecessary high cost. In some embodiments, the system for shipping an object may utilize machine learning and/or artificial intelligence algorithms to tackle these challenges and to make solutions fast and robust:

Predictive routing module: as new shipping requests come in, vehicle routes may need to be adjusted to accommodate the new requests. Route alterations may lead to inefficient detours, or in abandonment of some requests to avoid delays in the rest of the shipments. To mitigate this risk, in some embodiments, the machine learning algorithms may forecast and consider possible future demands based on historical demands and other relevant information. Specifically, the machine learning algorithms may assign an independent or joint distribution probability to future demands. The machine learning algorithms may further perform demand scenario analyses using statistical procedures (e.g., Monte Carlo simulation, bootstrapping), and predict the cost of potential route and transshipment alterations. In some embodiments, the machine learning algorithms may select an optimal route where the expected alteration cost is minimal or below a specific threshold. In some embodiments, the demand prediction module may use machine learning algorithms such as XGBoost to predict the demand quantity and characteristic for each potential location or area. The module may switch to use a deep-learning-based method as more data is collected. The switching time may be chosen by continuously training both the algorithms and evaluating their performance until one outperforms the other. The algorithm switching time may be different depending on the market, or location, or the available data.

Customer clustering module: transshipment decisions may be a function of many factors, including but not limited to courier characteristics (e.g., type, cost, range, capacity), transshipment cost, delivery characteristics (e.g., dimensions, weight, type, delivery location) and the number of deliveries considered for each transshipment. Various factors may be considered for each delivery to determine whether the delivery would be a part of transshipment. Thus, finding the optimal decisions is computationally intensive. In some embodiments, the module utilizes clustering-based heuristics that combine multiple deliveries based on delivery characteristics (e.g., package dimensions, weight, type, delivery location), courier characteristics, transshipment cost, and vehicle type and number to be considered for transshipment. The vehicle type for each transshipment may eventually be determined by the routing engine. In some embodiments, for each vehicle type, there may be a subset of deliveries that could be combined. In some embodiments, the module regularly precomputes the subsets for each vehicle type using clustering algorithms (e.g., density-based spatial clustering, hierarchical clustering) and estimates delivery costs for these bundle/vehicle combinations. A delivery bundle may appear as one shipment with its required vehicle type to the eye of the routing engine. The routing engine may choose the optimal bundle/vehicle combinations for transshipment that minimize the overall objective function. In some embodiments, the routing engine may solve mini-routing problems for each of the clusters, and pre-compute the cost of each cluster to feed into the global routing optimization. The number of customers, and the shape of clusters may be vehicle dependent, and more than one clustering scenario may be generated for the same set of delivery points depending on the vehicle types available. For example, while two delivery points may fall into one cluster given a drone delivery, they may fall into separate clusters if a bike delivery is available instead.

Synchronization module: each transshipment requires synchronizing the arrival times of vehicles involved, and a transshipment hub. Synchronization is a component of the system for shipping an object as timely deliveries depend on a seamless and timely transshipment process. This includes both the synchronization of transshipment among the involved vehicles, and synchronization of their arrival times with the transshipment hub reserved time because early or late arrivals could result in hub unavailability or delivery delays. Given the stochastic nature of arrival times, in some embodiments, the module may use dynamic statistical procedures (e.g., reinforcement learning, approximate dynamic programming) to continuously improve the quality of synchronization. In the reinforcement learning paradigm, the “agent” determines the timing of dispatch decision for the second leg of the transshipment based on various network related factors (such as traffic condition, weather condition), package related factors (such as weight, dimensions, value), and delivery-vehicle related factors (such as type, courier company, driver information). As more data is consumed by the module, its ETA prediction accuracy, and its ability to differentiate between the reliability level of different couriers improves. The reward function in this paradigm may be defined based on the cost of misalignment, which may be a function of, including but not limited to, missed transshipment, wasted delivery time, and the probability of late delivery.

In some embodiments, the system for shipping an object can use the Internet of Things (IoT) to provide precision logistics and more visibility and trackability to shippers. As a non-limiting example, the collaborative logistics system may use an Automatic Identification and Data Capture (AIDC) (e.g., radio-frequency identification (RFID)) chip implemented in a parcel's label and other technologies including but not limited to, Bluetooth™, cellular, Wi-Fi, and GPS to track the status and condition of a parcel throughout the transition. In some embodiments, the collaborative logistics system may provide real-time updates to shippers on shipments' location, temperature, barometric pressure, and light exposure, as well as traffic data, weather conditions. In addition, in some embodiments, the collaborative logistics system may receive information and data from delivery vehicles equipped with IoT sensors and use that information to optimize routing and make the delivery process more efficient. As a non-limiting example, the collaborative logistics system may collect vehicle locations, wheel speed, engine revs, fuel consumption, braking, cornering speed, closeness to other vehicles, and distance from curbsides, dynamic characteristics (accessibility, exposure to sun, wind, and rain) of possible transshipment hubs, as well as the driving and moving behavior of drivers and feed them back to the routing engine and scheduling engine to be used to achieve one or more goals including but not limited to faster and safer delivery, lowering pollution or traffic congestion, lowering the probability of accidents, and meeting some city or community requirements or regulations.

In some embodiments, the collaborative logistics system may use IoT sensors and chips to track the chain of custody of parcels and navigate delivery vehicles. As a non-limiting example, delivery vehicles may be equipped with a sensor that identifies each parcel using a Bluetooth chip or RFID tag implanted on the parcel and send back this real-time information to the collaborative logistics system. In addition, delivery vehicles may use Bluetooth- or RFID-based sensors or readers to communicate with each other their locations, estimated time of arrival, and other information during transshipment or final drop-off. As a non-limiting example, parcel receivers may use uniquely designed RFID equipment to send the precise location information of where they would like parcels to be delivered by drones or bots.

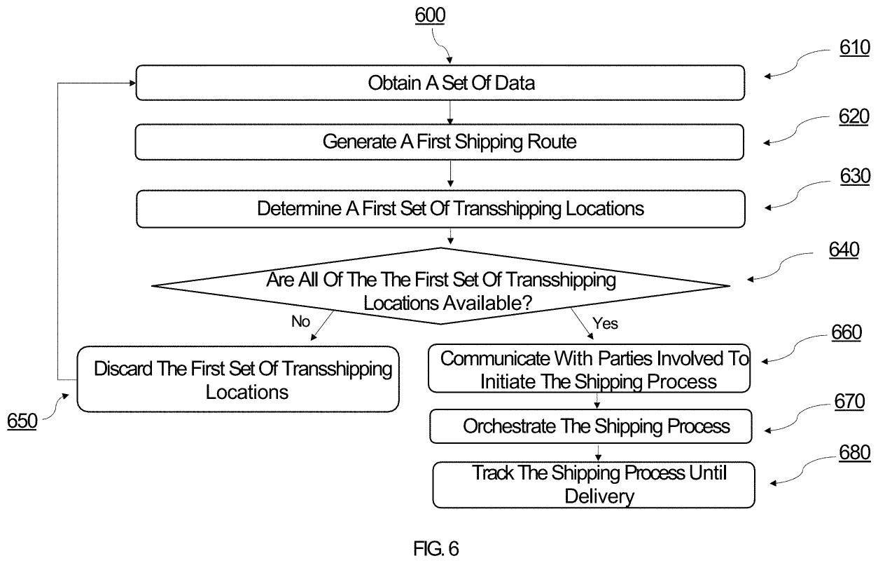

Referring to FIG. 6, a flowchart depicting a process 600 for shipping an object in accordance with an embodiment of the disclosure is shown. The process 600 can obtain a set of data, as shown by block 610. The process 600 can then generate a first shipping route, as shown by block 620. The process 600 can determine a first set of transshipping locations for the first shipping route, as shown by block 630. The process 600 can proceed and determine whether all of the first set of transshipping locations are available, as shown by block 640. If at least one of the first set of transshipping locations is not available, then the process 600 can discard the first set of transshipping locations, as shown by block 650, and move back to obtain another set of data and generate another shipping route. Upon a determination that all of the first set of transshipping locations are available, the process 600 can communicate with parties involved to initiate the shipping process, as shown by block 660. The process 600 can then orchestrate the initiated shipping process, as shown by block 670. The process 600 can proceed to track the shipping process until the object is delivered to the final destination, as shown by block 680.

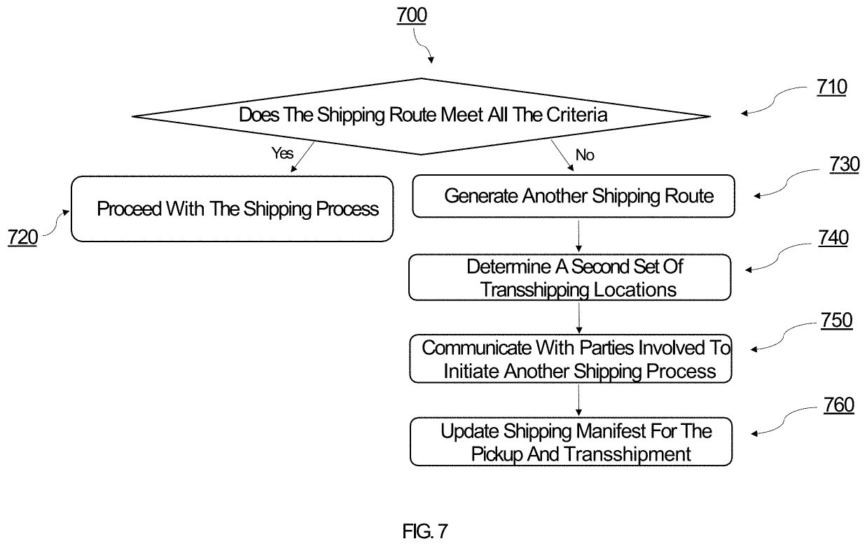

FIG. 7 is a flowchart depicting a process 700 for updating the shipping process for shipping an object in accordance with an embodiment of the disclosure. The process 700 can determine whether the shipping route meets all the criteria, as shown by. Block 710. Upon a determination that the shipping route does meet all of the criteria, the process 700 can proceed with the shipping process, as shown by block 720. Once the shipping route fails to meet all of the criteria, the process 700 can generate another shipping route, as shown by block 730. The process 700 can proceed to determine a second set of transshipping locations, as shown by block 740. The process 700 can then communicate with parties involved to initiate another shipping process, as shown by block 750. The process 700 can subsequently update a shipping manifest for the pick-up and transshipment, as shown by block 760.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A system for shipping an object, comprising:
a routing unit configured to:
obtain a set of data associated with the object to be shipped;
generate a first shipping route for the object based at least in part on the set of data; and
determine a first set of transshipping locations for the shipping route, wherein each of the first set of transshipping locations comprises a location that the object is transferred from a first courier to a second courier; and
a scheduling unit communicatively coupled to the routing unit, wherein the scheduling unit is configured to:
determine an availability for each of the first set of transshipping locations;
upon a first determination that the first set of transshipping locations are available, communicate with parties involved in shipping the object to initiate a shipping process; and
orchestrate the shipping process along the shipping route until the object is delivered to a final destination,
wherein upon a second determination that the first shipping route does not meet one or more pre-determined criteria, the scheduling unit is further configured to at least: direct the routing unit to generate a second shipping route for the object, determine a second set of transshipping locations.

2. The system of claim 1, wherein the first and second set of transshipping locations comprise at least one of: a pre-negotiated public transit space, a pre-negotiated private parking lot, a pre-negotiated loading dock, a pre-negotiated retail parking lot, a pre-negotiated curb space, a pre-negotiated building roof, a pre-negotiated bridge, a pre-negotiated private driveway, a dynamically sourced space from a space provider, and a pre-negotiated backyard.

3. The system of claim 1, wherein the set of data comprises at least one of pick-up location of the object, a pick-up time window of the object, and a type of vehicle that can perform the pick-up based at least on a size, shape and weight of the object.

4. The system of claim 1, wherein the set of data comprises at least one of object specifications, a delivery location, and a delivery time window.

5. The system of claim 1, wherein the set of data comprises at least a number of available vehicles of each courier, a vehicle capacity of each of the available vehicles of each courier, a vehicle range of each of the available vehicles of each courier, a vehicle size of each of the available vehicles of each courier, a vehicle emission of each of the available vehicles of each courier, a vehicle availability time of each of the available vehicles of each courier, and cost of shipping process.

6. The system of claim 1, wherein the set of data comprises at least one of: a location of the final destination, a number of transshipments that a courier can handle at a same time, and an available time of each of the first set of transshipping locations.

7. The system of claim 1, wherein each of the set of data is a location-dependent data or a time-dependent data.

8. The system of claim 1, wherein the routing engine is configured to determine the first set of transshipping locations based at least on: a cost of total distance traveled associated with the delivery process, a cost of total delivery time, a total cost of transshipping, and an environmental cost of the delivery process, wherein the total cost of transshipping includes at least a total hub cost and a total waiting cost.

9. The system of claim 2, wherein the set of data comprises at least one of a number of available spaces for each of the first and second set of transshipping locations, a notice time needed to secure a space for each of the first and second set of transshipping locations, and a capacity of available spaces for each of the first and second set of transshipping locations.

10. The system of claim 1, wherein the parties involved in the shipping the object to initiate the shipping process are at least one of a courier, a shipper of the object, a recipient of the object, and an operator associated with each of the first and second sets of transshipping locations.

11. The system of claim 1, further comprising:
a simulation unit configured to analyze shipping routes by running one or more simulations based on at least one of: the set of data, the first set of transshipping locations, traffic data along the shipping route, and weather conditions.

12. The system of claim 1, wherein each of the first and second couriers is at least one of: a vehicle, a drone, a bike, a boat, a public transit vehicle, a motorcycle, and an on-foot person.

13. The system of claim 1, wherein the one or more pre-determined criteria comprise at least one of: an expected delivery window time, and an expected delivery cost.

14. The system of claim 1, wherein upon the second determination, the scheduling unit is further configured to:
update shipping manifests for the pickup and transshipment.

15. A method for shipping an object, comprising:
obtaining a set of data associated with the object to be shipped;
generating a first shipping route for the object based at least in part on the set of data;
determining a first set of transshipping locations for the shipping route, wherein each of the first set of transshipping locations comprises a location that the object is transferred from a first courier to a second courier;
determining an availability for each of the first set of transshipping locations;
upon a first determination that the first set of transshipping locations of the shipping route are available, communicating with parties involved in the shipping the object to initiate a first shipping process;
orchestrating the first shipping process along the shipping route until the object is delivered to a final destination;
tracking the first shipping process along the shipping route until the object is delivered to a final destination; and
upon a second determination that the first shipping route does not meet one or more pre-determined criteria,
generating a second shipping route for the object;
determining a second set of transshipping locations; and
communicating with parties involved in the shipping the object to initiate a second shipping process.

16. The method of claim 15, wherein the first and second set of transshipping locations comprise at least one of: a pre-negotiated public transit space, a pre-negotiated private parking lot, a pre-negotiated loading dock, a pre-negotiated retail parking lot, a pre-negotiated curb space, a pre-negotiated building roof, a pre-negotiated bridge, a pre-negotiated private driveway, a dynamically sourced space from a space provider, and a pre-negotiated backyard.

17. The method of claim 15, wherein determining the first set of transshipping locations ids performed based at least on: a cost of total distance traveled associated with the delivery process, a cost of total delivery time, a total cost of transshipping, and an environmental cost of the delivery process, wherein the total cost of transshipping includes at least a total hub cost and a total waiting cost.

18. The method of claim 15, wherein the set of data comprises at least one of a pick-up location of the object, a pick-up time window of the object, a type of vehicle that can perform the pick-up based at least on a size, a shape and a weight of the object, and a pick-up hour, one or more object specifications, a delivery location, a delivery time window, a number of available vehicles of each courier, a vehicle capacity of each of the available vehicles of each courier, a vehicle range of each of the available vehicles of each courier, a vehicle size of each of the available vehicles of each courier, a vehicle emission of each of the available vehicles of each courier, a cost of shipping process, a vehicle availability time of each of the available vehicles of each courier, a location of the final destination, a number of transshipments that a courier can handle as a same time, and an available time of each of the first set of transshipping locations.

19. The method of claim 15, further comprising:
upon the second determination, updating shipping manifests for the pickup and transshipment.

20. The method of claim 15, further comprising:
analyzing each shipping route by running one or more simulations based on at least one of: the set of data, the first set of transshipping locations, traffic data along the shipping route, and weather conditions.
